(19) United States
(12) Patent Application Publication
(10) Pub. No.: US 2026/0251241 A1
(43) Pub. Date: Aug. 27, 2026

(54) FLEXIBLE PIPE BODY

(71) Applicant: Baker Hughes Energy Technology UK Limited, Bristol (GB)

(72) Inventors: Andrew THOMPSON, Bristol (GB); Peter John KIRTON, Bristol (GB); Brendan O'DONNELL, Bristol (GB)

(21) Appl. No.: 18/876,961

(22) PCT Filed: Jun. 23, 2023
(86) PCT No.: PCT/EP2023/025291

§ 371 Date: Dec. 19, 2024

(30) Foreign Application Priority Data
Jun. 24, 2022 (GB) 2209311.6

(51) Int. Cl. F16L 11/08

(52) U.S. Cl. CPC F16L 11/083

(57) ABSTRACT

The present disclosure relates to a flexible pipe body for conveying high pressure fluid. The flexible pipe body comprises a tubular fluid sealing layer, a pressure retaining armour layer positioned over the tubular fluid sealing layer, and a tensile armour layer positioned over the pressure retaining armour layer. The tubular fluid sealing layer comprises a composition comprising a plasticizer and a homopolymer of vinylidene fluoride, and wherein said plasticizer is present in an amount of 0.3 to 2.0 weight % based on the total weight of the polymer composition.

### TECHNICAL FIELD

The invention relates to a flexible pipe body for conveying high pressure fluid e.g. to and from a subsea location.

### BACKGROUND

Flexible pipe can be utilised to transport production fluids, such as oil and/or gas and/or water, from one location to another. Flexible pipe is particularly useful in connecting a sub-sea location (which may be deep underwater) to a sea level location. The pipe may have an internal diameter of typically up to around 0.6 metres (e.g. diameters may range from 0.05 m up to 0.6 m). Flexible pipe is generally formed as an assembly of a flexible pipe body and one or more end fittings. The pipe body is typically formed as a combination of layered materials that form a pressure-containing conduit. The pipe structure allows large deflections without causing bending stresses that impair the pipe's functionality over its lifetime. The pipe body is generally built up as a combined structure including polymer, and/or metallic, and/or composite layers. For example, a pipe body may include polymer and metal layers, or polymer and composite layers, or polymer, metal and composite layers.

API Recommended Practice 17B provides guidelines for the design, analysis, manufacture, testing, installation, and operation of flexible pipes and flexible pipe systems for onshore, subsea and marine applications.

In many flexible pipe designs the pipe body includes one or more armour layers positioned over a tubular polymer layer. The primary load on such armour layers is formed from radial forces. Armour layers often have a specific cross section profile to interlock so as to be able to maintain and absorb radial forces resulting from outer or inner pressure on the pipe. The cross sectional profile of the wound wires which thus prevent the pipe from collapsing or bursting as a result of pressure are sometimes called pressure-resistant profiles. When armour layers are formed from helically wound wires forming hoop components, the radial forces from outer or inner pressure on the pipe cause the hoop components to expand or contract, putting a tensile load on the wires.

The polymer layers of flexible pipe bodies may be formed by extrusion. For at least some polymers, including polymers of vinylidene fluoride, plasticizers are commonly used as a processing aid to ensure that the tubular layer can be extruded, and the extruded tube is sufficiently flexible to provide a pipe which maintains desired storage and operating bend radii without damage or making the pipe too stiff. For homopolymers of vinylidene fluoride, plasticizer amounts of 3 weight % or greater are typically employed to provide the resulting polymer composition with the processability required to form tubular fluid sealing layers of flexible pipes. An example of a suitable plasticizer is dibutyl sebacate.

The application of internal pressure (i.e. pressure from within the bore) to the pipe produces radial expansion in the fluid sealing and layers outside of it. This is when a polymer layer can undergo deformation and creep into the gaps of an overlying armour layer. At high pressures (about 8000 psi/55 MPa or more), the resultant strain distribution within the polymer fluid sealing layer can be highly localised at the areas around the gaps. This can result in a strain distribution through the thickness of the polymer leading to highly stressed areas at or near the inner surface of the polymer fluid barrier sealing layer between the areas of peak strain at the outside diameter of the same layer, and at these locations of enhanced stress the polymer material may deform by cavitation rather than plastic flow. This can in turn result in the formation of microcrazing or microcracking on those radially inner surface locations of the polymer fluid barrier sealing layer. During any subsequent loading (such as the loading experienced during normal use in transporting production fluids) this microcrazing may then extend to form longer and/or deeper cracks throughout the polymer layer. This can increase the risk of failure of the polymer layer and may ultimately lead to loss of pressure containment, having an adverse effect on the lifetime of a flexible pipe.

Additionally the lifetime of the pipe may be limited by the fatigue life of the layers within the pipe structure. The polymer layers are critical to the containment of the fluids in the pipe and as such must have assured fatigue performance, but this can be adversely affected by the aging of the polymer layer as, over time, plasticizer can leach out of the polymer and hydrocarbons can enter the polymer, causing it to swell. These physical changes to the polymer can lead to a reduction in flexibility and consequently fatigue life.

### BRIEF DESCRIPTION OF THE DRAWINGS

FIG. 1 illustrates a flexible pipe body according to an embodiment of the present invention;

FIG. 2 illustrates an example of a riser assembly suitable for transporting production fluid such as oil and/or gas and/or water from a sub-sea location to a floating facility; and

FIG. 3 shows the comparison of removal of plasticiser over time from GRADES 3 & 4.

### DESCRIPTION

According to an aspect of the invention, there is provided a flexible pipe body for conveying high pressure fluid. The flexible pipe body comprises a tubular fluid sealing layer, a pressure retaining armour layer positioned over the tubular fluid layer, and a tensile armour layer positioned over the pressure retaining armour layer. The tubular fluid sealing layer comprises a polyvinylidene fluoride (PVDF) polymer composition comprising a plasticizer and a homopolymer of vinylidene fluoride. The plasticizer is present in an amount of 0.3 to 2 weight % based on the total weight of the polymer composition.

According to a further aspect of the invention, there is provided a method of producing a flexible pipe body. The method comprises extruding a tubular fluid sealing layer from a PVDF polymer composition comprising a homopolymer of vinylidene fluoride and plasticizer, wherein the plasticizer is present in an amount of 0.3 to 2 weight % based on the total weight of the polymer composition. The method further comprises positioning a pressure retaining armour layer over the tubular fluid sealing layer, and positioning a tensile armour layer over the pressure retaining armour layer.

Plasticizers (e.g. dibutyl sebacate) are often incorporated into polymer compositions used to form tubular fluid sealing layers for flexible pipe bodies. Typically, plasticizers (e.g. dibutyl sebacate) are included in amounts of 3 weight % or more to provide the polymer composition with the processibility required for extrusion to form the tubular sealing layer. Some polymer compositions may be devoid of plasticizer. However, to provide the desired processibility, such compositions typically contain significant amounts of low viscosity polymeric components that can affect other mechanical properties of the polymer composition.

The present inventors have found that plasticizer levels can be optimised at 0.3 to 2 weight %. Surprisingly, when plasticizer levels are reduced from known levels to levels of 0.3 to 2 weight %, the crazing and/or fatigue performances of the flexible pipe body can be maintained. This is unexpected since higher amounts of plasticizer would be expected to improve the flexibility and flow properties of the polymer composition, making it less likely to crack. It has been found that, by using plasticiser in amounts of 0.3 to 2 weight %, it is still possible to provide the polymer composition with the processability required for e.g. extruding the tubular fluid sealing layer, while maintaining the crazing and fatigue performances of the resulting layer, and improving aging performance.

It has also been found that, with prolonged use, plasticizer can be stripped out of the tubular fluid sealing layer through interactions with e.g. hydrocarbons flowing through the flexible pipe body. Loss of plasticizer can result in a loss of volume in the tubular fluid sealing layer, as well as stiffening of the polymer. This can have a detrimental effect on the performance of the tubular fluid sealing layer, and can also compromise the secure retention of end-fittings to the flexible pipe body as the polymer may shrink away from sealing rings, reducing seal or even resulting in loss of containment. Reducing the amount of plasticizer can reduce the extent of volume loss, while improving long-term properties, such as resistance to crazing as mentioned above, and fatigue performance.

The plasticizer may be present in an amount of 0.5 to 1.9 weight % based on the total weight of the polymer composition. For example, the plasticizer may be present in an amount of 1.0 to 1.9 weight %, preferably 1.3 to 1.8 weight %, more preferably, 1.5 to 1.7 weight %.

Any suitable plasticizer may be employed. An example may be dibutyl sebacate.

The polymer composition may comprise 50 to 85 weight % of the homopolymer of vinylidene fluoride. In some examples, the homopolymer of vinylidene fluoride may be present in an amount of 60 to 80 weight %, based on the total weight of the polymer composition.

The homopolymer of vinylidene fluoride may comprise polymer chains of ultra-high molecular weight, for instance material of molecular weight greater than 3,000,000 g/mol.

The homopolymer of vinylidene fluoride may have a melt flow index of less than or equal to 15 g/min, for example, less than 10 g/min or less than 5 g/min according to ISO 1133 (230° C., 12.5 kg).

The polymer composition may further comprise a copolymer of vinylidene fluoride. The copolymer of vinylidene fluoride may be a copolymer of vinylidene fluoride and a comonomer. The comonomer may be selected from at least one of vinyl fluoride; trifluoroethylene; chlorotrifluoroethylene (CTFE); 1,2-difluoroethylene; tetrafluoroethylene (TFE); hexafluoropropylene (HFP); perfluoro (alkylvinyl) ethers; such as perfluoro(methylvinyl) ether (PMVE); perfluoro (ethylvinyl) ether (PEVE) or perfluoro (propylvinyl) ether (PPVE); perfluoro (2,3-dioxole); perfluoro (2,2-dimethyl-1,3-dioxole) (PDD); the comonomer of formula CF₂═CFOCF₂CF(CF₃)OCF₂CF₂X, in which X is SO₂F, CO₂H, CH₂OH, CH₂OCN or CH₂OPO₃H; the comonomer of formula CF₂═CFOCF₂CF₂SO₂F; the comonomer of formula F(CF₂)ₙCH₂OCF═CF₂ in which n is 1, 2, 3, 4 or 5; the comonomer of formula R₁CH₂OCF═CF₂ in which R₁ is hydrogen or F(CF₂)_{z} and z has the value 1, 2, 3 or 4, the comonomer of formula R₃OCF═CH₂ in which R₃ is F(CF₂)_{z} and z has the value 1, 2, 3 or 4; perfluorobutylethylene (PFBE); fluorinated ethylene propylene (FEP); 3,3,3-trifluoropropene; 2-trifluoromethyl-3,3,3-trifluoro-1-propene; 2,3,3,3-tetrafluoropropene or HFO-1234yf; E-1,3,3,3-tetrafluoropropene or HFO-1234zeE; Z-1,3,3,3-tetrafluoropropene or HFO-1234zeZ; 1,1,2,3-tetrafluoropropene or HFO-1234yc; 1,2,3,3-tetrafluoropropene or HFO-1234ye; 1,1,3,3-tetrafluoropropene or HFO-1234zc; and chlorotetrafluoropropene or HCFO-1224.

According to a preferred embodiment, the comonomer is hexafluoropropylene (HFP). The copolymer may be present in the composition in a proportion by weight of more than 10 to 40%, based on the total weight of the polymer composition. The copolymer may be present in an amount of 15 to 40%, preferably of 17 to 35%. In some examples, the comonomer may be present in the copolymer composition in an amount of 25 to 40 weight %.

The proportion by weight of comonomer in the vinylidene fluoride copolymer is greater than 25%. Advantageously, it is: greater than or equal to 26%, and/or less than or equal to 40%, preferably less than or equal to 37%.

The polymer composition may further comprise a second homopolymer of vinylidene fluoride presenting different properties from the first homopolymer of vinylidene fluoride, for instance a different viscosity in Pa·s when measured at a temperature of 230° C. and a shear of 100 s⁻¹ using a capillary rheometer in the molten state.

The second homopolymer of vinylidene fluoride may be present in the amount 1 to 20 weight %, in particular from 5 to 20 weight % and preferably from 5 to 15 weight %.

Where the second homopolymer of vinylidene fluoride is present, the ratio of apparent melt viscosities of the first homopolymer to the second homopolymer may be regrater than or equal to 5, for example, greater to or equal to 10 or greater to or equal to 50. The apparent melt viscosities can be expressed as Pa·s and measured on a capillary rheometer at a temperature of 230° C. and a shear rate of 100 s⁻¹.

The polymer composition may be formed using any suitable method, for example, by blending the polymer components in the molten or dry state.

The polymer composition may have a density of at least 1.65 gcm⁻³ as measured according to ISO 1183 or ASTM D792. In some examples, the polymer composition may have a density of 1.70-1.75 gcm⁻³ as measured according to ISO 1183.

The polymer composition may have a melting point of at least 160° C. determined by ISO 11357-2. In some examples, the polymer composition of the tubular layer may have a melting point of 165-170° C. determined by ISO 11357-2.

The polymer composition may have a tensile strength at yield of at least 30 MPa according to ASTM D 638 at 23° C., 50 mm/min. The polymer composition may have a tensile strength at break of at least 30 MPa according to ASTM D 638 at 23° C., 50 mm/min.

The polymer composition may comprise fillers (e.g. fibres of carbon, glass, basalt, or particles such as clay/silicates, carbonates, metal oxides). Where the polymer composition comprising fillers comprises fibres, those fibres may be provided in the form of a tape comprising long fibres orientated in the length direction of the tape; the tape also comprising a matrix of the polymer composition which may be helically wound around the pipe body and later consolidated using heat and/or pressure to form a composite pipe layer. The fillers may provide a reduction in permeability of the polymer layer to gases, and/or strengthening to the layer.

The maximum operating temperature of the tubular fluid sealing layer may be greater than 130° C., for example, greater than 140° C. This is determined through creep testing and aging data where samples of polymer are immersed in hydrocarbon media (for instance diesel) for periods of time to simulate service; this can strip out plasticizer and result in the absorption of hydrocarbons into the polymer, changing its physical and mechanical properties. Those properties may be determined in accordance with normal test standards, as referenced in API 17J.

It has been found that, by using plasticiser in amounts of 0.3 to 2 weight %, it is possible to produce a tubular fluid sealing layer with a higher maximum operating temperature than most PVDF materials, while maintaining crazing and fatigue performance, and improving aging performance.

It has also be found that the selected plasticizer content may be reduced from higher levels of e.g. 3 weight % to 0.3 to 2 weight % while maintaining the permeation characteristics of the polymer, as can be seen in the examples below.

The tubular fluid sealing layer may have a diameter of from 50 mm to 600 mm, for example, 50 to 400 mm. The thickness of the tubular sealing layer may be from 1 to 50 mm, for example 5 to 20 mm. The length of the tubular sealing layer may be from 10 m to 10 km, or more.

In use, the tubular fluid sealing layer is in contact with the fluid flowing through the flexible pipe body. For example, the tubular fluid sealing layer may be the inner pressure sheath of the flexible pipe body. In some examples, a carcass layer (e.g. metal carcass layer) may be positioned within the tubular fluid sealing layer, so that the flexible pipe body has a rough bore. However, even with a carcass layer, the fluid flowing through the flexible pipe body contacts the tubular fluid sealing layer, as fluid seeps through joins in the carcass layer.

A pressure retaining armour layer is positioned over the tubular fluid sealing layer. The pressure retaining armour layer may be disposed around the tubular sealing layer by winding. The pressure retaining armour layer may surround the tubular fluid sealing layer. The pressure retaining armour layer may be in direct contact with the tubular fluid sealing layer.

The application of internal pressure (i.e. pressure from within the bore) to the pipe produces radial expansion in all layers. This is when a tubular fluid sealing layer can undergo deformation and creep into the gaps of an overlying pressure retaining armour layer. At high pressures (about 8000 psi/55 MPa or more), the resultant strain distribution within the tubular fluid sealing polymer layer can be highly localised at the areas around the gaps, and the polymer composition of the tubular fluid sealing layer may deform by cavitation rather than plastic flow. This can in turn result in the formation of microcrazing or microcracking on the radially inner surface of the polymer layer. During any subsequent loading (such as the loading experienced during normal use in transporting production fluids) this microcrazing may then extend to form longer and/or deeper cracks throughout the polymer layer. This can increase the risk of failure of the polymer layer and may ultimately lead to loss of pressure containment, having an adverse effect on the lifetime of a flexible pipe. By using plasticizer in amounts of 0.3 to 2 weight %, the risk of crazing and cracking is surprisingly reduced. Accordingly, the polymer composition employed in the present invention can be used to provide a tubular fluid sealing layer having improved crazing performance compared to prior art tubular fluid sealing layers where higher amounts of plasticizer are employed.

The pressure retaining armour layer may comprise at least one wire, for example, at least one metal wire. Alternatively, the pressure retaining armour layer may comprise a composite structure of fibre elements and a polymer matrix. In some examples, the pressure retaining armour layer may comprise at least one layer of wound composite tape. The composite tape may be at least partially bonded to the underlying fluid sealing layer. The composite tape may comprise a polymer matrix comprising a homopolymer of vinylidene fluoride according to the invention.

The pressure retaining armour layer may be a structural layer. The layer may be formed from metal wire or composite tape that is wound around the tubular fluid sealing layer. The pressure retaining armour layer may be wound e.g. with a lay angle close to 90°. This can increase the resistance of the flexible pipe to internal and external pressure and mechanical crushing loads. The pressure retaining armour layer can also structurally support the tubular fluid sealing layer. The pressure retaining armour layer may have an interlocked construction.

A tensile armour layer is positioned over the pressure retaining armour layer. The tensile armour layer may be disposed around the pressure retaining armour layer by winding. The pressure retaining armour layer may surround the pressure retaining armour layer. The tensile armour layer may be in direct contact with the pressure retaining armour layer. In some examples, at least one intervening layer may be provided between the tensile armour layer and the pressure retaining armour layer. The intervening layer(s) may act as a sacrificial wear layer to help prevent abrasion between adjacent layers.

The tensile armour layer comprises a plurality of helically wound tendons. The tendons can comprise metal wires or composite fibre elements. In some examples, more than one tensile armour layer may be provided. For example, the flexible pipe body may comprise a first tensile armour layer and a second tensile armour layer. Each tensile armour layer may be a structural layer. The lay angle of the tensile armour layer may be typically between 10° and 55°. Each layer may be used to sustain tensile loads and internal pressure. Tensile armour layers can be counter-wound in pairs.

The flexible pipe body can include layers of insulation. The flexible pipe body can also include an outer sheath. The outer sheath can comprises a polymer layer used to protect the pipe against penetration of seawater and other external environments, corrosion, abrasion and mechanical damage.

The flexible pipe body can be used to transport fluids, such as oil and/or gas and/or water, from one location to another. In some examples, the flexible pipe body is used to transfer fluids to and from a sub-sea location. The subsea location may be deep underwater, e.g. 1000 metres or more, or just below sea level. The flexible pipe body may have an internal diameter of typically up to around 0.6 metres.

The flexible pipe body may be provided with one or more end fittings to form flexible pipe. The end fittings of a flexible pipe may be used for connecting segments of flexible pipe body together or for connecting them to terminal equipment such as a rigid sub-sea structures or floating facilities. As such, amongst other varied uses, flexible pipe can be used to provide a riser assembly for transporting fluids from a sub-sea flow line to a floating structure. In such a riser assembly a first segment of flexible pipe may be connected to one or more further segments of flexible pipe. Each segment of flexible pipe includes at least one end fitting.

The flexible pipe body may be used to form unbonded flexible pipe. In unbonded pipe, the layers are not bonded together during manufacture. Accordingly, for example, the tubular fluid sealing layer is not bonded to the pressure retaining armour layer during manufacture. API Specification 17J titled “Specification for Unbonded Flexible Pipe” defines the technical requirements for safe, dimensionally and functionally interchangeable flexible pipes that are designed and manufactured to uniform standards and criteria.

In certain embodiments, the flexible pipe body delivers fluid under pressure. The pressure may be in excess of 100 psi (~700 kPa) and/or up to 24,000 psi (~165 MPa). Additionally, or alternatively, the method may comprise the step of maintaining pressure in the fluid for a predetermined period of time to fix the radial movement of the fluid sealing layer. Maintaining pressure in the fluid may comprise maintaining a pressure in excess of 100 psi (~700 kPa) and/or up to 24,000 psi (~165 MPa).

The features of all the above-described embodiments are intended to be combinable with one another, unless mutually exclusive.

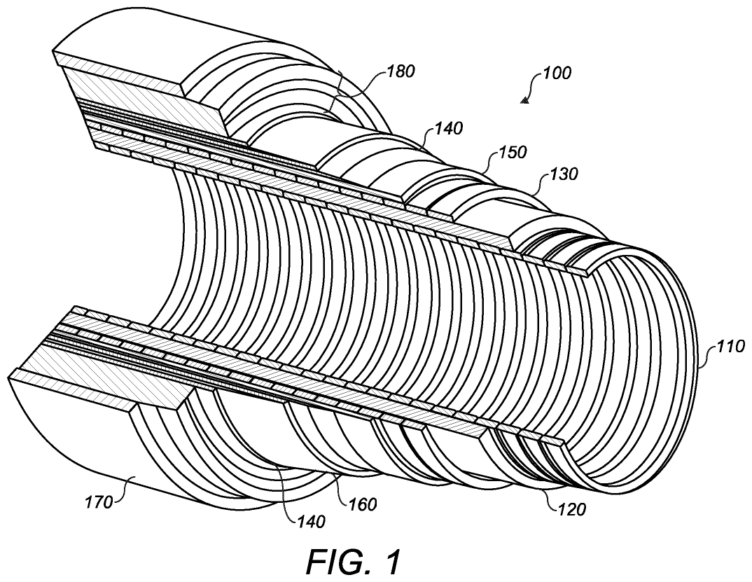

FIG. 1 illustrates how a flexible pipe body 100 is formed in accordance with an embodiment of the present invention from a combination of layered materials. It is to be noted that the layer thicknesses are shown for illustrative purposes only.

As illustrated in FIG. 1, a flexible pipe body can include an optional innermost carcass layer 101. The carcass provides an interlocked construction that can be used as the innermost layer to prevent, totally or partially, collapse of a tubular fluid sealing layer 102 (or internal pressure sheath) due to pipe decompression, external pressure, and tensile armour pressure and mechanical crushing loads. It will be appreciated that certain embodiments of the present invention are applicable to ‘smooth bore’ operations (i.e. without a carcass) as well as such ‘rough bore’ applications (with a carcass).

The tubular fluid sealing layer 102 can act as a fluid retaining layer and is formed of a polymer layer that ensures internal fluid integrity. It is to be understood that this layer may itself comprise a number of sub-layers. It will be appreciated that when the optional carcass layer is utilised the tubular fluid sealing layer is often referred to by those skilled in the art as a barrier layer. In operation without such a carcass (so-called smooth bore operation) the tubular fluid sealing layer may be referred to as a liner.

A pressure retaining armour layer 103 is provided around the tubular fluid sealing layer 102. The pressure retaining armour layer may be a structural layer with e.g. a lay angle close to 90° that increases the resistance of the flexible pipe to internal and external pressure and mechanical crushing loads. The layer can also structurally support the tubular fluid sealing layer. The pressure retaining armour layer 103 may have an interlocked construction, or comprise layers of helically wound composite tape which are consolidated to form a composite pressure armour layer.

The flexible pipe body also includes a tensile armour layer over the pressure retaining armour layer 103. As shown in FIG. 1, the flexible pipe body may comprise a first tensile armour layer 105 and a second tensile armour layer 106. Each tensile armour layer may be a structural layer with a lay angle typically between 10° and 55°. Each layer may be used to sustain tensile loads and internal pressure. The tensile armour layers can be counter-wound in pairs.

The flexible pipe body shown also includes optional layers of tape 104 which contain underlying layers and may act as a sacrificial wear layer to help prevent abrasion between adjacent layers.

The flexible pipe body can also include optional layers of insulation 107 and an outer sheath 108, which comprises a polymer layer used to protect the pipe against penetration of seawater and other external environments, corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

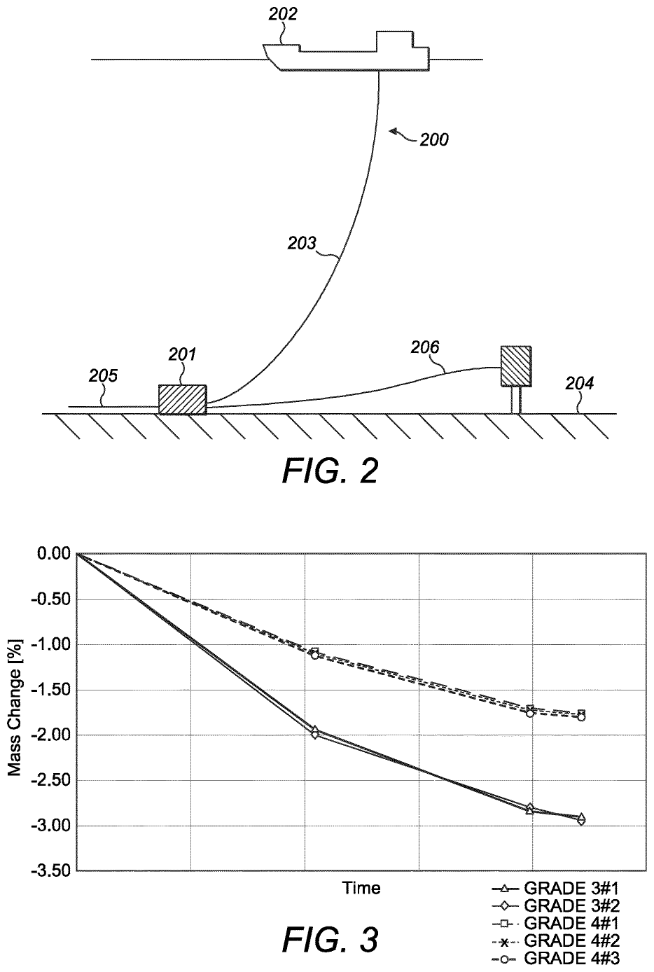

FIG. 2 illustrates an example of a riser assembly 200 suitable for transporting production fluid such as oil and/or gas and/or water from a sub-sea location 201 to a floating facility. For example, in FIG. 2 the sub-sea location 201 includes a sub-sea flow line. The flexible flow line 205 comprises a flexible pipe, wholly or in part, resting on the sea floor 204 or buried below the sea floor and used in a static application. The floating facility may be provided by a platform and/or buoy or, as illustrated in FIG. 2, a ship 200. The riser assembly 200 is provided as a flexible riser, that is to say a flexible pipe 203 connecting the ship to the sea floor installation. The flexible pipe may be in segments of flexible pipe body with connecting end fittings.

It will be appreciated that there are different types of riser, as is well-known by those skilled in the art. Embodiments may be used with any type of riser, such as a freely suspended (free, catenary riser), a riser restrained to some extent (buoys, chains), totally restrained riser or enclosed in a tube (I or J tubes).

FIG. 2 also illustrates how portions of flexible pipe can be utilised as a flow line 205 or jumper 206.

Various modifications to the detailed arrangements as described above are possible. For example, the polymeric layer may be any layer of the pipe body and is not limited to the liner or barrier layer. The strength layer may similarly be any layer of the flexible pipe body such as a pressure armour layer, a tensile armour layer, etc. The polymeric layer need not be directly adjacent to the strength layer; there may be intermediate layers such as a sacrificial tape layer. For flexible pipe body with more than one polymeric layer, the method described above may be employed more than once so as to treat each of the polymeric layers in turn or concurrently. The treatment stage may be performed on a barrier layer with a carcass layer present, since a carcass layer is not fluid-tight and will allow pressurised fluid to flow therebetween to access the polymeric barrier layer.

The strength layer may not be a carbon steel wire as described above but may be made from a stainless steel wire or strip, a reinforced polymer composite material or other such suitable material, and of any suitable cross section.

The invention is not restricted to the details of any foregoing embodiments. It will be appreciated by those skilled in the art that several variations to the aforementioned embodiments are envisaged without departing from the scope of the invention, for example the pressurised fluid may be supplied between the sleeve and the further sleeve through a single inlet.

The invention extends to any novel one, or any novel combination, of the features disclosed herein (including those of the accompanying claims and drawings). The claims should not be construed to cover merely the foregoing embodiments, but also any embodiments which fall within the scope of the claims.

All of the features disclosed herein (including those of the accompanying claims and drawings) may be combined in any combination, except combinations where at least some of such features are mutually exclusive. Moreover, each feature disclosed herein (including those of the accompanying claims and drawings) may be replaced by alternative features serving the same, equivalent or similar purpose, unless expressly stated otherwise. Thus, unless expressly stated otherwise, each feature disclosed is one example only of a generic series of equivalent or similar features.

### EXAMPLES

As can be seen in the Tables 1 and 2 below the PVDF polymer material with lower plasticiser (GRADE 4) presents improvements in fatigue and crazing performance compared with many PVDF materials (GRADES 1 & 2), and does not suffer any deterioration in properties from a similar PVDF material (GRADE 3) with higher plasticizer content, while maintaining permeation and fatigue performance. FIG. 3 also shows the comparison of removal of plasticiser over time from GRADES 3 & 4 for comparison showing the benefit from reducing the plasticiser content of the polymer.

The performance of a polymer sealing layer of flexible pipe body may be assessed through many testing regimes to understand its physical and mechanical properties. These include permeation, ductile brittle transition temperature, and fatigue performance. The first two of these may be seen in relation to four commercially available grades of PVDF polymer in Table 1; the maximum operating temperatures, fatigue performance and crazing performance for the same four PVDF polymers may be seen in Table 2.

TABLE 1

| | | | | Permeation Coefficients | | | | |
|---|---|---|---|---|---|---|---|---|
| | | | | (ISO 2556 and ISO 15105-1) | | | | |
| | | | | CO2 | H2S | CH4 | | |
| | | | | (100° C., | (100° C., | (100° C., | | |
| | | | | 8 bar) | 10 bar) | 10 bar) | Ductile | |
| | | Nominal | Plasticiser | [cm³(STP) | [cm³(STP) | [cm³(STP) | Brittle | |
| PVDF | Polymer | Plasticiser | Content | cm/cm² | cm/cm² | cm/cm² | Transition | |
| Grade | Composition | Content | Range | s bar] | s bar] | s bar] | ISO-179 | |
| GRADE 1 | Two thirds PVDF | 0% | N/A | 1.92E−07 | 1.92E−07 | 2.55E−08 | 15 to 25° | C. |
| | homopolymer and one third | | | | | | | |
| | PVDF-CTFE copolymer. | | | | | | | |
| GRADE 2 | Approximately 95% PVDF | 3% | 2.8-3.6% | 3.76E−07 | 2.48E−07 | 2.38E−08 | 0 to 15° | C. |
| | homopolymer | | | | | | | |
| | 3.2% nominal plasticiser | | | | | | | |
| | (DBS, Dibutyl sebacate) | | | | | | | |
| | 2.2% nominal impact | | | | | | | |
| | modifier (elastomeric) | | | | | | | |
| GRADE 3 | PVDF (polyvinylidene | 3% | 2.6-3.4% | 2.48E−07 | 2.80E−07 | 3.42E−08 | −15 to −10° | C. |
| | fluoride) homopolymer with | | | | | | | |
| | VDF-HFP copolymer | | | | | | | |
| | (vinylidene fluoride - | | | | | | | |
| | hexafluoropropylene), | | | | | | | |
| | Approximately 3% DBS | | | | | | | |
| | (dibutyl sebacate) | | | | | | | |
| | plasticizer. | | | | | | | |
| GRADE 4 | PVDF (polyvinylidene | 1.7% | 1.5-1.9% | 2.48E−07 | 2.80E−07 | 3.42E−08 | −15 to −10° | C. |
| | fluoride) homopolymer with | | | | | | | |
| | VDF-HFP copolymer | | | | | | | |
| | (vinylidene fluoride - | | | | | | | |
| | hexafluoropropylene), | | | | | | | |
| | Approximately 1.7% DBS | | | | | | | |
| | (dibutyl sebacate) | | | | | | | |
| | plasticizer. | | | | | | | |

TABLE 2

| | | | | | | Crazing |
|---|---|---|---|---|---|---|
| | | Nominal | Plasticiser | Max | Fatigue | Resistance |
| PVDF | Polymer | Plasticiser | Content | Operating | (Relative | (Relative |
| Grade | Composition | Content | Range | Temperature | performance)* | Performance)** |
| GRADE 1 | Two thirds PVDF | 0% | N/A | 130° C. | 1/10 | 5/10 |
| | homopolymer and one third | | | | | |
| | PVDF-CTFE copolymer. | | | | | |
| GRADE 2 | Approximately 95% PVDF | 3% | 2.8-3.6% | 130° C. | 1/10 | 5/10 |
| | homopolymer | | | | | |
| | 3.2% nominal plasticiser | | | | | |
| | (DBS, Dibutyl sebacate) | | | | | |
| | 2.2% nominal impact | | | | | |
| | modifier (elastomeric) | | | | | |
| GRADE 3 | PVDF (polyvinylidene | 3% | 2.6-3.4% | 140° C. | 10/10 | 10/10 |
| | fluoride) homopolymer with | | | | | |
| | VDF-HFP copolymer | | | | | |
| | (vinylidene fluoride - | | | | | |
| | hexafluoropropylene), | | | | | |
| | Approximately 3% DBS | | | | | |
| | (dibutyl sebacate) | | | | | |
| | plasticizer. | | | | | |
| GRADE 4 | PVDF (polyvinylidene | 1.7% | 1.5-1.9% | 140° C. | 10/10 | 10/10 |
| | fluoride) homopolymer with | | | | | |
| | VDF-HFP copolymer | | | | | |
| | (vinylidene fluoride - | | | | | |
| | hexafluoropropylene), | | | | | |
| | Approximately 1.7% DBS | | | | | |
| | (dibutyl sebacate) | | | | | |
| | plasticizer. | | | | | |

*Fatigue performance based on small-scale tests on samples of extruded polymers from pipe, including all pipe features inherent in that layer. Fatigue testing performed using four-point bend testing to develop fatigue s-n curves, using a setup based upon ASTM D6272-10 and a strain-controlled methodology, as also described in conference paper OTC-27260 presented at Offshore Technology Conference in Houston, May 2016, and also in conference paper OMAE-23573 presented at the International Conference on Offshore Mechanics and Arctic Engineering in San Francisco, June 2014. 1/10 indicates material not achieving 10 million load cycles at strain ranges below 0.5%; 10/10 indicates material achieving >10 million load cycles at strain ranges below 0.5%.
**The crazing performance is based on the pressure testing of sections of extruded fluid sealing layer restrained by a simulated pressure armour layer up to at least 24,000 psi using water as the pressurizing medium, confirmed by pressure testing using pipe at full scale (all layers). This has been described at conference, for instance MCE Deepwater Development presentation “Challenges and Solutions in Developing Ultra-high Pressure Flexibles for Ultra-deep water Applications” by Dr Upul Fernando, in London, March 2015. 5/10 indicates only minor crazing visible when testing pipe suitable for 10,000 psi design pressure; 10/10 indicates no crazing when testing pipe suitable for in excess of 10,000 psi design pressure.

1. A flexible pipe body for conveying high pressure fluid, comprising:
a tubular fluid sealing layers;
a pressure retaining armour layer positioned over the tubular fluid sealing layer; and,
a tensile armour layer positioned over the pressure retaining armour layer;
wherein the tubular fluid sealing layer comprises a composition comprising a plasticizer and a homopolymer of vinylidene fluoride, and wherein said plasticizer is present in an amount of 0.3 to 2.0 weight % based on the total weight of the polymer composition.

2. The flexible pipe body as claimed in claim 1, wherein the polymer composition comprises 1.5 to 1.9 weight % based on the total weight of the polymer composition.

3. The flexible pipe body as claimed in claim 1, wherein the polymer composition further comprises a copolymer of vinylidene fluoride.

4. The flexible pipe body as claimed in claim 3, wherein the copolymer of vinylidene fluoride is a copolymer of vinylidene fluoride and hexafluoropropylene.

5. The flexible pipe body as claimed in claim 3, wherein the copolymer of vinylidene fluoride is present in an amount of 10 to 40 weight % based on the total weight of the polymer composition.

6. The flexible pipe body as claimed in claim 1, wherein the polymer composition has a density of at least 1.65 gem-3 as measured according to ISO 1183 or ASTM D792.

7. The flexible pipe body as claimed in claim 6, wherein the polymer composition has a density of 1.70-1.75 gem-3 as measured according to ISO 1183 or ASTM D792.

8. The flexible pipe body as claimed in claim 1, wherein the polymer composition of the tubular layer has a melting point of at least 160° C. determined by ISO 11357-2.

9. The flexible pipe body as claimed in claim 8, wherein the polymer composition of the tubular layer has a melting point of 165-170° C. determined by ISO 11357-2.

10. The flexible pipe body as claimed in claim 1, wherein the polymer composition has a tensile strength at yield of at least 30 MPa according to ASTM D 638 at 23° C., 50 mm/min.

11. The flexible pipe body as claimed in claim 1, wherein the polymer composition has a tensile strength at break of at least 30 MPa according to ASTM D 638 at 23° C., 50 mm/min.

12. The flexible pipe body as claimed in claim 1, wherein the amount of plasticizer is 1.6 to 1.8 weight % based on the total weight of the polymer composition.

13. The flexible pipe body as claims in claim 1, wherein the pressure retaining armour layer comprises at least one metal wire.

14. The flexible pipe body as claimed in claim 1, wherein the pressure retaining armour layer comprises a composite structure of fibre elements and a polymer matrix.

15. The flexible pipe body as claimed in claim 14, wherein the pressure retaining armour layer comprises at least one layer of helically wound composite tape, the composite tape being at least partially bonded to the underlying fluid sealing layer, and wherein the polymer matrix comprises a homopolymer of vinylidene fluoride.

16. The flexible pipe body as claims in claim 1, wherein the tensile armour layer comprises a plurality of helically wound tendons, the tendons optionally comprising metal wires or composite fibre elements.

17. A method of producing a flexible pipe body as claimed in claim 1, said method comprising extruding a tubular fluid sealing layer from a polymer composition comprising a homopolymer of vinylidene fluoride and plasticizer, wherein the plasticizer is present in an amount of 0.3 to 2 weight % based on the total weight of the polymer composition; positioning a pressure retaining armour layer over the tubular fluid sealing layer; and positioning a tensile armour layer over the pressure retaining armour layer.
